(19) United States
(12) Patent Application Publication
(10) Pub. No.: US 2025/0068922 A1
(43) Pub. Date: Feb. 27, 2025

(54) SYSTEMS AND METHODS FOR GENERATING SYNTHETIC DATA BASED ON ABANDONED WEB ACTIVITY

(71) Applicant: Capital One Services, LLC, McLean, VA (US)

(72) Inventors: Joshua EDWARDS, Philadelphia, PA (US); Benjamin ENG, Silver Spring, MD (US); Youbing YIN, McLean, VA (US)

(73) Assignee: Capital One Services, LLC, McLean, VA (US)

(21) Appl. No.: 18/452,731

(22) Filed: Aug. 21, 2023

(51) Int. Cl. G06N 3/094; G06N 3/045; G06N 3/0475

(52) U.S. Cl. CPC G06N 3/094; G06N 3/045; G06N 3/0475

(57) ABSTRACT

Methods and systems for generating synthetic training data based on abandoned web activity data are described herein. In some aspects, the system determines that a user abandoned a user activity included in web activity data for the user. The system processes, using a first machine learning model, the abandoned web activity data to generate a probability for each entry in the abandoned web activity data. Each probability indicates a likelihood that the abandoned user activity would have been completed. The system generates a synthetic dataset that includes abandoned web activity with a probability above a threshold. The system uses the synthetic dataset to train a second machine learning model. The system tests the machine learning model using a testing dataset based on completed user activities.

### SUMMARY

In recent years, the use of artificial intelligence, including, but not limited to, machine learning, deep learning, etc. (referred to collectively herein as “artificial intelligence models,” “machine learning models,” or simply “models”), has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. One such problem is the scarcity of training data for training machine learning models.

Machine learning algorithms require large amounts of high-quality data to learn how to make accurate predictions or classifications. Without enough data, the machine learning algorithm may not be able to recognize patterns and relationships in the data and may not be able to generalize well to new, unseen examples. When there is a scarcity of training data, the machine learning model may suffer from overfitting, which means it has learned the training data too well and is not able to generalize well to new examples. Alternatively, it may suffer from underfitting, where the model is too simple to capture the complexity of the problem at hand. In addition, the quality of the training data is also important. If the data is biased or contains errors, the machine learning model may learn these biases and errors and produce inaccurate results. Therefore, having access to a large and diverse dataset is crucial for training accurate and reliable machine learning models.

Some existing systems use synthetic training data to address a lack of high-quality data for training machine learning models. Synthetic training data is artificially generated data that is created using computer algorithms or simulation models rather than being collected from real-world sources. Synthetic training data is often used to supplement or replace real-world data in machine learning models. While synthetic training data can be readily available, it is not always good for training machine learning models for a few reasons. First, synthetic data may not accurately capture the real-world variability of the data, leading to models that are less robust and less accurate when applied to real-world scenarios. Second, synthetic data may not represent the full range of scenarios that a machine learning model is likely to encounter in the real world. This can lead to models that are less effective at solving real-world problems. Finally, synthetic data can be biased if it is generated based on biased assumptions or if the underlying simulation models or algorithms have biases built into them. This can lead to models that perpetuate and amplify biases rather than mitigate them.

These technical problems may present an inherent problem with attempting to use an artificial intelligence-based solution in situations where sufficient training data is not available, such as for predicting a likelihood for a user to complete a future web activity when insufficient training data is available for completed web activities. Accordingly, methods and systems are described herein for novel uses and/or improvements to artificial intelligence applications. As one example, methods and systems are described herein for generating synthetic training data based on abandoned user activity data, such as web activity data.

Existing systems do not leverage abandoned web activity data to train a model to predict a likelihood for a user to complete a future web activity. While such data may be more readily available than completed web activity data, the abandoned web activity data may not include sufficient signals regarding whether a user will complete a future web activity. To overcome these technical deficiencies in adapting artificial intelligence models for this practical benefit of leveraging abandoned web activity data, methods and systems disclosed herein collect abandoned user activity data. The abandoned data could be used for the synthetic data generation, customer interest predictions and the abandonment reason understanding. In this manner, the systems and methods described herein leverage the best of both worlds by using real-world abandoned web activity data and combining it with the completed user activity data.

In some aspects, the problems described above may be solved using a system that may perform the following operations. The system may first determine that a user abandoned a user activity included in web activity data for the user. An abandoned user activity may relate to a web page that the user has accessed but not returned to for a threshold period of time. Then, the system may process, using a first machine learning model, the abandoned web activity data to generate a probability for each entry in the abandoned web activity data. Each probability indicates a likelihood that the abandoned user activity would have been completed. Then the system may generate a synthetic dataset. The synthetic dataset may include abandoned web activity with a probability above a threshold. Finally, the system may use the synthetic dataset to train, validate, or test a second machine learning model.

The system may determine that a user abandoned a user activity. In particular, the system may determine that a user abandoned a user activity included in web activity data for the user. An abandoned user activity may relate to a web page that the user has accessed but not returned to for a threshold period of time. Thus, the system can collect information on activities the user may abandon.

The system may insert the abandoned user activity into abandoned web activity data. In particular, the system may insert, into abandoned web activity data for a plurality of users, the abandoned user activity. Thus, the system can start generating a dataset of user abandoned activities.

The system may process the abandoned web activity data. In particular, the system may process, using a first machine learning model, the abandoned web activity data to generate a probability for each entry in the abandoned web activity data. Each probability for a corresponding entry of the abandoned web activity data indicates a likelihood that the abandoned user activity would have been completed.

The system may generate a synthetic dataset. In particular, the system may generate a synthetic dataset based on entries of the abandoned web activity data with a probability above a threshold. By doing so, the synthetic dataset may have sufficient information to help train a model to predict whether a user will complete a future web activity.

The system may train a machine learning model using the synthetic dataset. In particular, the system may train a second machine learning model using the synthetic dataset and test the second machine learning model using a completed activity dataset based on completed user activities. The completed activity dataset may include data distinctive from the synthetic dataset. The completed user activities relate to one or more web pages where the user has completed an action. By doing so, the system is able to generate a machine learning model that has more available data than previous models and is tuned to predict whether a user will complete a future web activity.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for detecting unauthorized user activities based on abandoned user activities, in accordance with one or more embodiments.

FIG. 2A and FIG. 2B show an illustrative diagram for generating a synthetic dataset based on entries of the abandoned web activity data as well as the completed dataset, in accordance with one or more embodiments.

FIG. 3 shows illustrative components for a system used alongside the machine learning models, in accordance with one or more embodiments.

FIG. 4 shows a flowchart of the steps involved in generating synthetic data based on abandoned web activity data, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

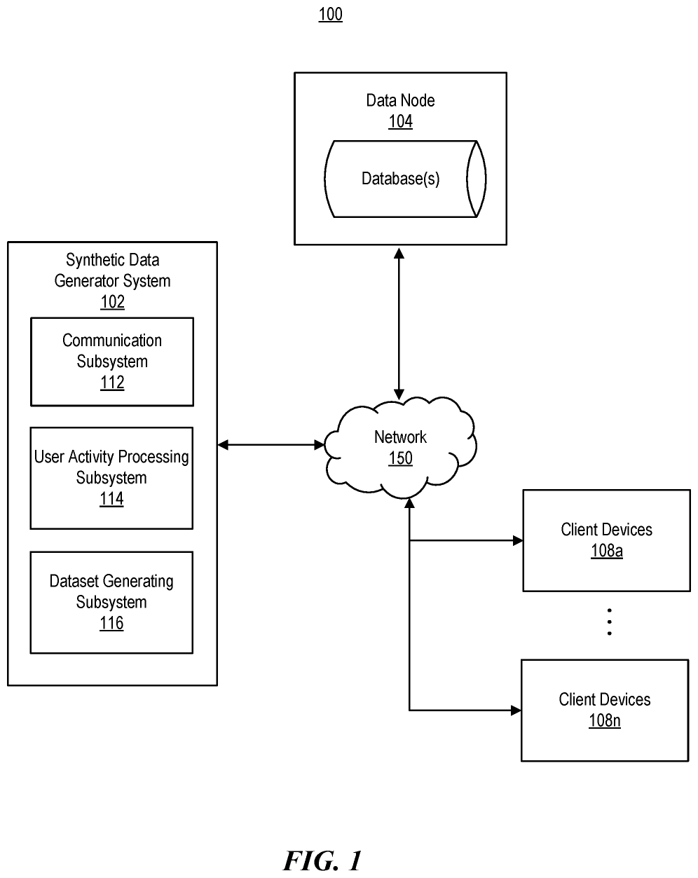

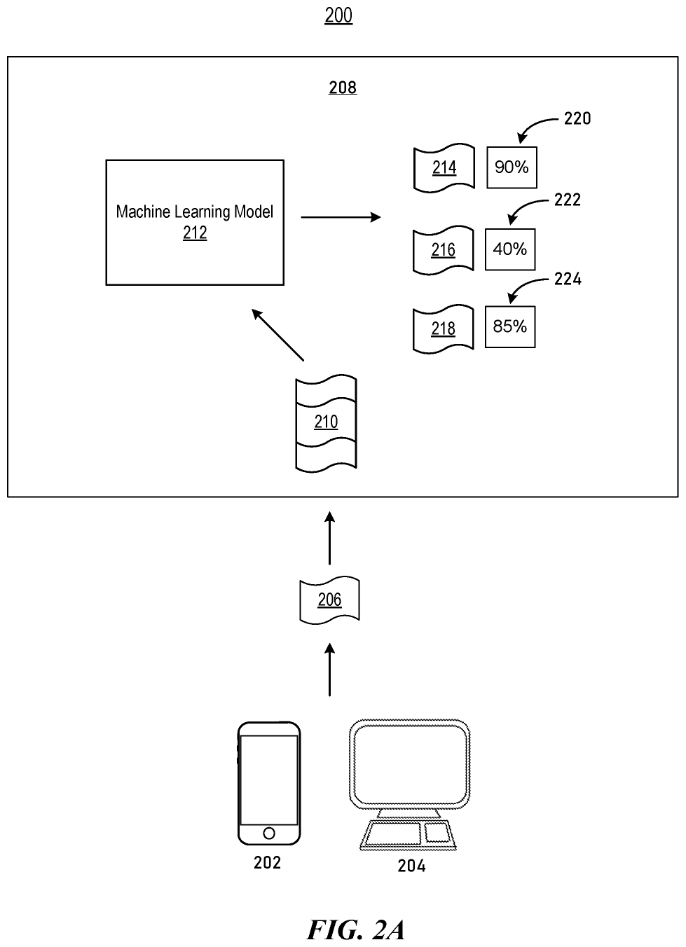

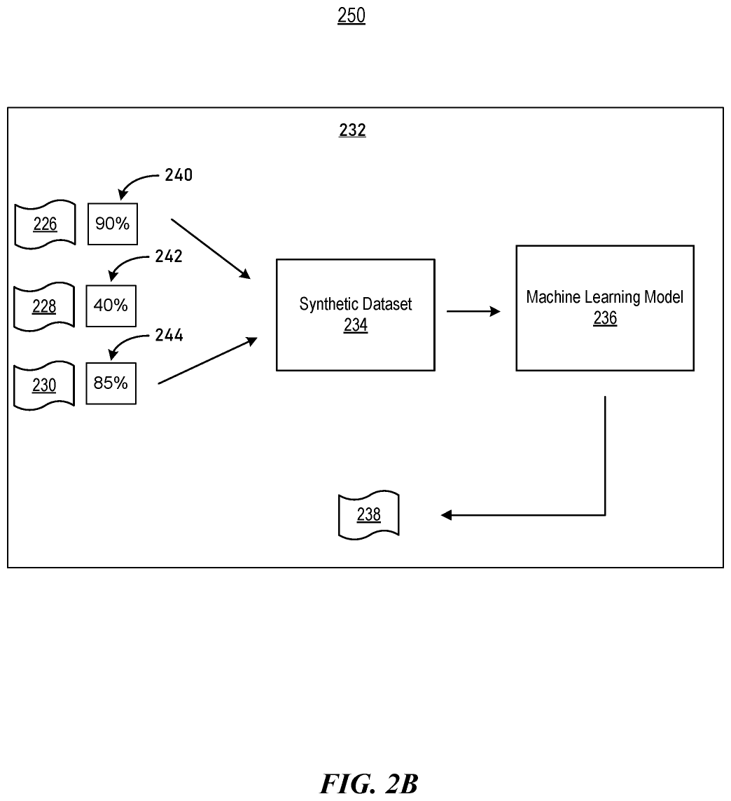

FIG. 1 shows an illustrative environment for detecting unauthorized user activities based on abandoned user activities, in accordance with one or more embodiments of this disclosure. Environment 100 includes synthetic data generator system 102, data node 104, and client devices 108a-108n. Synthetic data generator system 102 may include software, hardware, or a combination of both and may reside on a physical server or a virtual server running on a physical computer system (e.g., centralized server 208 described with respect to FIG. 2A). In some embodiments, synthetic data generator system 102 may be configured on a user device (e.g., a laptop computer, a smartphone, a desktop computer, an electronic tablet, or another suitable user device). Furthermore, synthetic data generator system 102 may reside on a cloud-based system and/or interface with computer models either directly or indirectly, for example, through network 150. Synthetic data generator system 102 may include communication subsystem 112, user activity processing subsystem 114, and/or dataset generating subsystem 116.

Data node 104 may store various data, including one or more machine learning models, training data, user data profiles, input data, output data, performance data, and/or other suitable data. Data node 104 may include software, hardware, or a combination of the two. In some embodiments, synthetic data generator system 102 and data node 104 may reside on the same hardware and/or the same virtual server or computing device. Network 150 may be a local area network, a wide area network (e.g., the Internet), or a combination of the two.

Client devices 108a-108n may include software, hardware, or a combination of the two. For example, each client device may include software executed on the device or may include hardware, such as a physical device. Client devices may include user devices (e.g., a laptop computer, a smartphone, a desktop computer, an electronic tablet, or another suitable user device).

Synthetic data generator system 102 may receive user data profiles from one or more client devices. Synthetic data generator system 102 may receive data using communication subsystem 112, which may include software components, hardware components, or a combination of both. For example, communication subsystem 112 may include a network card (e.g., a wireless network card and/or a wired network card) that is associated with software to drive the card and enables communication with network 150. In some embodiments, communication subsystem 112 may also receive data from and/or communicate with data node 104 or another computing device. Communication subsystem 112 may receive data, such as web activity data. Communication subsystem 112 may communicate with user activity processing subsystem 114 and dataset generating subsystem 116.

Synthetic data generator system 102 may include user activity processing subsystem 114. Communication subsystem 112 may pass at least a portion of the data or a pointer to the data in memory to user activity processing subsystem 114. User activity processing subsystem 114 may include software components, hardware components, or a combination of both. For example, user activity processing subsystem 114 may include software components or may include one or more hardware components (e.g., processors) that are able to execute operations for determining that a user abandoned a user activity. User activity processing subsystem 114 may access data, such as user activity data. User activity processing subsystem 114 may directly access data or nodes associated with client devices 108a-108n and may transmit data to these client devices. User activity processing subsystem 114 may, additionally or alternatively, receive data from and/or send data to communication subsystem 112 and dataset generating subsystem 116.

Dataset generating subsystem 116 may execute tasks relating to generating a synthetic dataset. Dataset generating subsystem 116 may include software components, hardware components, or a combination of both. For example, in some embodiments, dataset generating subsystem 116 may receive data input such as abandoned web activity and data output from a machine learning model. Dataset generating subsystem 116 may, additionally or alternatively, receive data from and/or send data to communication subsystem 112 or user activity processing subsystem 114.

FIG. 2A and FIG. 2B show an illustrative diagram for generating a synthetic dataset based on entries of the abandoned web activity data with a probability above a threshold, in accordance with one or more embodiments. FIG. 2A shows environment 200. Environment 200 includes user device 202, user device 204, user activity 206, centralized server 208, web activity data 210, machine learning model 212, abandoned web activity 214, abandoned web activity 216, abandoned web activity 218, probability 220, probability 222, and probability 224. Probability 220, probability 222, and probability 224 correspond to abandoned web activity 214, abandoned web activity 216, and abandoned web activity 218.

Centralized server 208 may determine that a user abandoned a user activity (e.g., user activity 206). In particular, the centralized server 208 may determine that a user abandoned a user activity (e.g., user activity 206) included in web activity data for the user (e.g., web activity data 210). An abandoned user activity may relate to a web page that the user has accessed but not returned to for a threshold period of time. For example, the system may receive the shows the user starts watching and when a user completes an episode. The system may determine the user has abandoned a show by detecting the user has clicked to watch an episode but did not complete watching the episode or did not play the next episode. In another example, the system may determine a user has added items to a shopping cart online but has not checked out or made a purchase yet. Thus, centralized server 208 can collect information on shows the user may abandon.

In some embodiments, centralized server 208 may receive web activity data (e.g., web activity data 210) for the user. In particular, centralized server 208 may receive web activity data (e.g., web activity data 210) for the user. The web activity data relates to a plurality of web pages accessed by the user. For example, the system may monitor a plurality of web pages for abandoned user activities such as cart abandonment.

In some embodiments, centralized server 208 may determine that the user abandoned a user activity included in the web activity data (e.g., web activity data 210) by identifying a web page associated with a user activity (e.g., user activity 206) after the threshold period of time. In particular, centralized server 208 may identify a web page associated with a user activity (e.g., user activity 206) after the threshold period of time. Centralized server 208 may search a completed user activity database for the user activity. In response to finding no completed user activity corresponding to the user activity, centralized server 208 may determine that the user has abandoned the user activity. In some embodiments, the completed user activity database may include a user identifier, a time identifier, and a web page identifier corresponding to each completed user activity. For example, the system may identify an incomplete online purchase that has not been completed within a time threshold. The system may search a completed user database that stores each purchase (e.g., user activity 206) associated with the time stamp and online merchant. After not finding the incomplete online purchase in the completed user database, the system ensures the user has abandoned the purchase. By doing so, the system is able to determine the user activity is abandoned by the user.

In some embodiments, the abandoned web activities may be processed to determine whether the abandoned web activities include any duplicated completed activities for the same user. For example, a similarity score could be calculated between the abandoned activities and completed activities. For instance, if the same shopping items are found between one abandoned activity and a complete activity with all the same other conditions such as item prices and the same credit card information, it is very likely the abandoned activities might be duplicated as the corresponding completed activities.

In some embodiments, centralized server 208 determines the time threshold based on the user activity (e.g., user activity 206). In particular, centralized server 208 may determine a first threshold period of time corresponding to a first user activity (e.g., user activity 206). Centralized server 208 may determine a second threshold period of time corresponding to a second user activity. The second threshold period of time is different from the first threshold period of time. For example, the time threshold for smaller purchases, such as clothing, may be set to one day. Meanwhile, the time threshold for larger purchases, such as furniture, may be set to three days. By doing so, the system is able to accurately determine whether user activity 206 was abandoned.

In some embodiments, centralized server 208 may store an abandoned user activity entry in an abandoned user activity database. In particular, centralized server 208 may store, in an abandoned user activity database, each abandoned user activity entry (e.g., abandoned web activity 214, abandoned web activity 216, and abandoned web activity 218) with the likelihood that the abandoned user activity would have been completed (e.g., probability 220, probability 222, and probability 224). Each abandoned user activity entry may include a user identifier, a time identifier, a web page identifier, and an activity identifier corresponding to the abandoned user activity. For example, the system may store each incomplete purchase in a database with the user account, the time stamp of when an item was added to a cart, and an identifier corresponding to the incomplete purchase. By doing so, the system is able to generate a synthetic dataset from the entries of incomplete purchases.

In some embodiments, centralized server 208 may generate for display user activities associated with the user. In particular, centralized server 208 may transmit a first request to a completed user activity database for completed user activity associated with the user. Centralized server 208 may transmit a second request to an abandoned user activity database for abandoned user activity entries associated with the user. In response to receiving the completed and abandoned user activities associated with the user, centralized server 208 may generate for display the completed and abandoned user activities on a user device associated with the user. For example, the system may display to the user all the purchases the user has completed and all the incomplete purchases the user has not made for a selected time period.

In some embodiments, centralized server 208 may determine whether the user abandoned a user activity (e.g., user activity 206) based on an interruption. In particular, centralized server 208 may determine that a user abandoned a user activity (e.g., user activity 206) included in web activity data (e.g., web activity data 210) for the user and may include detect in web activity data for the user, an interruption. The interruption is associated with a new user activity. The new user activity relates to a webpage that the user has accessed after an abandoned user activity. For example, the system may determine the user did not complete a first purchase because the user started another purchase. Therefore, the system can accurately determine whether the user abandoned the user activity and how likely it is the user will complete the purchase in the future.

Centralized server 208 may insert the abandoned user activity (e.g., user activity 206) into abandoned web activity data (e.g., web activity data 210). In particular, centralized server 208 may insert, into abandoned web activity data (e.g., web activity data 210) for a plurality of users, the abandoned user activity (e.g., user activity 206). For example, the system may collect abandoned shows from multiple users. Thus, the system can start generating a dataset of user abandoned activities.

Centralized server 208 may process the abandoned web activity data (e.g., web activity data 210). In particular, centralized server 208 may process, using a first machine learning model (e.g., machine learning model 212), the abandoned web activity data (e.g., web activity data 210), to generate a probability (e.g., probability 220, probability 222, and probability 224 for each entry in the abandoned web activity data (e.g., abandoned web activity 214, abandoned web activity 216, and abandoned web activity 218)). Each probability for a corresponding entry of the abandoned web activity data indicates a likelihood that the abandoned user activity would have been completed. For example, a user may usually only watch romance shows. Then, the user starts an episode of an action show. The system may determine the probability of the user watching that show is 30 percent. In comparison, the probability the user will watch another romance show is 90 percent. By doing so, the system is able to determine the likelihood a user will finish an episode based on previous watching history. In another example, abandoned web activities 214-218 may represent three separate abandoned carts. Abandoned web activity 214 has a likelihood of 90 percent of being completed based on the machine learning model, as shown by probability 220. Abandoned web activity 216 has a likelihood of 40 percent of being completed based on the machine learning model, as shown by probability 222. Abandoned web activity 218 has a likelihood of 85 percent of being completed based on the machine learning model, as shown by probability 224.

In some embodiments, a similarity score could be calculated between the abandoned activities and completed activities. If the similarity score is higher than a threshold, centralized server 208 may analyze the different factors between the abandoned activities and the complete activities. These factors might be able to help the system understand the key factors for users to make the final decision. For example, in online shopping, these factors could include but not limited to price drops of items, better credit card bonus, enough credit balance. The information could be later used for credit recommendation, promotion, balance adjustment, or loan offering.

In some embodiments, centralized server 208 may generate the likelihood based on previous activities. In particular, the first machine learning model (e.g., machine learning model 212) generates the likelihood that the abandoned user activity would have been completed based on previous activities. For example, abandoned web activity 214 may include an incomplete purchase, such as an abandoned cart with clothing. Based on previous purchases of clothing items from that online merchant, machine learning model 212 may determine probability 220 of the user completing the purchase is 90 percent.

FIG. 2B shows environment 250. Environment 250 includes abandoned web activity 226, abandoned web activity 228, abandoned web activity 230, centralized server 232, synthetic dataset 234, machine learning model 236, output 238, probability 240, probability 242, and probability 244.

In some embodiments, centralized server 232 may be the same as centralized server 208 in environment 200. In some embodiments, abandoned web activities 226, 228, and 230 may be the same as abandoned web activities 214, 216, and 218 in environment 200. Probability 240, probability 242, and probability 244 correspond to abandoned web activity 226, abandoned web activity 228, and abandoned web activity 230.

Centralized server 232 may generate a synthetic dataset (e.g., synthetic dataset 234). In particular, centralized server 232 may generate a synthetic dataset (e.g., synthetic dataset 234) based on entries of the abandoned web activity data with a probability above a threshold (e.g., abandoned web activities 226 and 230). For example, the synthetic dataset may only have entries of abandoned trailers where the probability is higher than 80 percent. By doing so, the synthetic dataset will be as accurate as possible for the user.

In some embodiments, the synthetic data can be generated using deep learning models such as generative adversarial networks. For example, the generative adversarial network may modify some or all features of the abandoned activity data to become synthetic data based on learning from the completed activities data.

In some embodiments, centralized server 232 may generate a value for a missing identifier. In particular, centralized server 232 may identify a missing identifier for a user activity in a completed user activity database. Centralized server 232 may generate a value for the missing identifier using a generative adversarial network. The generative adversarial network is trained using the synthetic dataset 234. For example, the system may identify a missing identifier and utilize a generative adversarial network to generate the value. Centralized server 232 may train a machine learning model (e.g., machine learning model 236) using the synthetic dataset (e.g., synthetic dataset 234). In particular, centralized server 232 may train, a second machine learning model (e.g., machine learning model 236), using the synthetic dataset (e.g., synthetic dataset 234), and test, the second machine learning model (e.g., machine learning model 236), using a completed activity dataset based on completed user activities. The completed activity dataset may include data distinctive from the synthetic dataset (e.g., synthetic dataset 234). The completed user activities relate to one or more web pages where the user has completed an action. In some embodiments, centralized server 232 may train, using the completed activity dataset, the second machine learning model (e.g., machine learning model 236), and test, the second machine learning model (e.g., machine learning model 236), using the synthetic dataset (e.g., synthetic dataset 234). For example, synthetic dataset 234 may include data from abandoned episodes. The completed activity dataset may include data from previous shows the user has completed watching. In another example, synthetic dataset 234 may include data from an abandoned cart, and the completed activity dataset may include data from completed purchases. By doing so, the system is able to generate a machine learning model that has more data than previous models and is tuned for that user to detect unauthorized user activities. For example, previously, abandoned activities data was used to send follow-up reminders to users. However, by utilizing data from abandoned carts (e.g., synthetic dataset) the system may generate better machine learning models that are able to predict customer interests by using both the synthetic dataset and the completed activity dataset. For instance, different weights or category labels could be assigned to these two groups as the additional inputs. Since there is a large amount of the abandoned activities data, the generated machine learning models are more robust than those previously built only with completed activities data.

In some embodiments, centralized server 232 may generate output 238. In particular, centralized server 232 may generate output 238 using the second machine learning model (e.g., machine learning model 236). The output may include a likelihood for the user to complete a future user activity when input into the machine learning model. For example, the second machine learning model may generate an output used to determine a user's abandonment reason. The system may analyze the differences between similar pair of an abandoned activity and a completed activity and find out the significant predictors by comparing original abandoned activity features and the modified features machine learning models to determine the predictors related to why a user may abandon an activity.

Overall, a user can be online shopping, and while a user is online shopping, the system can receive web activity data 206. In response to receiving user activity data 206, the system may determine a user has added items to a shopping cart online but has not checked out or made a purchase yet. For instance, the system can determine if the user has an abandoned shopping cart within user activity data 206. The system can capture and store the abandoned cart data of multiple users as web activity data 210. Using machine learning model 212, the system can calculate a likelihood score of how likely the user was to complete the transaction at that vendor as shown in FIG. 2A. This likelihood score could be used in various ways, such as generating synthetic datasets.

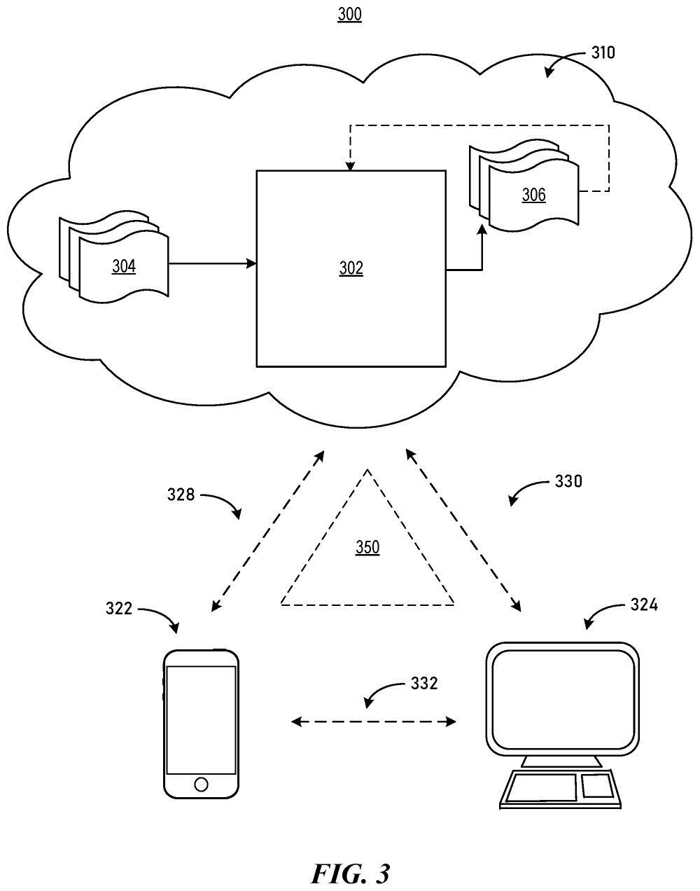

FIG. 3 shows illustrative components for a system used to generate synthetic training data based on abandoned web activity data, in accordance with one or more embodiments. For example, FIG. 3 may show illustrative components for detecting unauthorized user activities based on abandoned user activities. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted that while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as a touchscreen smartphone and a personal computer, respectively, these displays also act as user input interfaces. It should be noted that in some embodiments, the devices may have neither user input interfaces nor displays and may instead receive and display content using another device (e.g., a dedicated display device such as a computer screen and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, a magnetic hard drive, a floppy drive, etc.), electrical charge-based storage media (e.g., EEPROM, RAM, etc.), solid-state storage media (e.g., a flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include synthetic data generator system 102, communication subsystem 112, user activity processing subsystem 114, dataset generating subsystem 116, data node 104, or client devices 108a-108n and may be connected to network 150. Cloud components 310 may access user activity (e.g., user activity 206).

Cloud components 310 may include model 302, which may be a machine learning model, artificial intelligence model, etc. (which may be referred to collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., whether a user will complete an abandoned user activity).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, backpropagation techniques may be utilized by model 302, where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., user activity likely to be completed or user activity likely to not be completed).

In some embodiments, the model (e.g., model 302) may automatically perform actions based on outputs 306. In some embodiments, the model (e.g., model 302) may not perform any actions. The output of the model (e.g., model 302) may be used to generate a synthetic dataset using abandoned user activities.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be a REST or web services API layer) may provide a decoupled interface to data and/or functionality of one or more applications. API layer 350 may provide a common, language-agnostic way of interacting with an application. Web services APIs offer a well-defined contract called WSDL that describes the services in terms of its operations and the data types used to exchange information. REST APIs do not typically have this contract; instead, they are documented with client libraries for most common languages, including Ruby, Java, PHP, and JavaScript. SOAP web services have traditionally been adopted in the enterprise for publishing internal services, as well as for exchanging information with partners in B2B transactions.

API layer 350 may use various architectural arrangements. For example, system 300 may be partially based on API layer 350 such that there is a strong adoption of SOAP and RESTful Web services using resources like Service Repository and Developer Portal but with low governance, standardization, and separation of concerns. Alternatively, system 300 may be fully based on API layer 350 such that separation of concerns between layers like API layer 350, services, and applications is in place.

In some embodiments, the system architecture may use a microservice approach. Such systems may use two types of layers: a front-end layer and back-end layer, where microservices reside. In this kind of architecture, the role of the API layer 350 may provide integration between the front end and back end. In such cases, API layer 350 may use RESTful APIs (exposition to the front end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open-source API platforms and their modules. API layer 350 may use a developer portal. API layer 350 may use strong security constraints applying WAF and DDOS protection, and API layer 350 may use RESTful APIs as a standard for external integration.

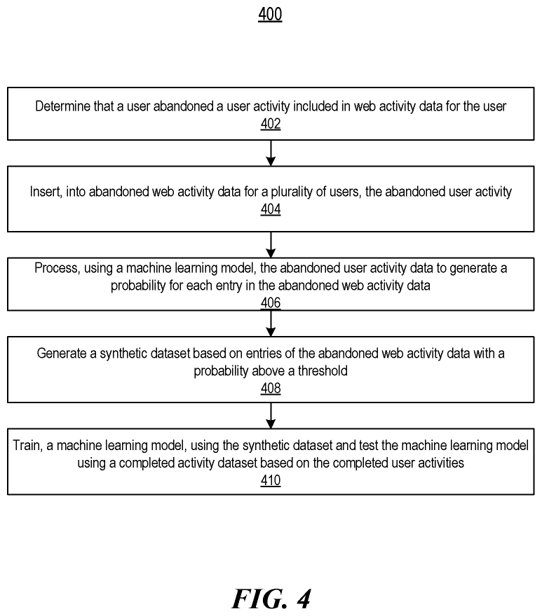

FIG. 4 shows a flowchart of the steps involved in generating a synthetic dataset based on abandoned web activity data, in accordance with one or more embodiments. For example, the system may use process 400 (e.g., as implemented on one or more system components described above) in order to detect unauthorized user activities based on abandoned user activities.

At operation 402, process 400 (e.g., using one or more components described above) may determine that a user abandoned a user activity included in web activity data for the user. An abandoned user activity may relate to a web page that the user has accessed but not returned to for a threshold period of time. For example, the user activity processing subsystem 114 may determine that a user abandoned a user activity (e.g., user activity 206) included in web activity data for the user (e.g., web activity data 210). By doing so, the system may collect the abandoned activity.

In some embodiments, the system may receive web activity data for the user. For example, the system may receive web activity data for the user. The web activity data relates to a plurality of web pages accessed by the user. For example, communication subsystem 112 may receive web activity data (e.g., web activity data 210) for the user. By doing so, the system may monitor a plurality of web pages for abandoned user activities.

In some embodiments, the system may determine that the user abandoned a user activity included in the web activity data by identifying a web page associated with a user activity after the threshold period of time. For example, the system may identify a web page associated with a user activity after the threshold period of time. The system may search a completed user activity database for the user activity. For example, user activity processing subsystem 114 may identify a web page associated with a user activity (e.g., user activity 206) after the threshold period of time. User activity processing subsystem 114 may search a completed user activity database for the user activity. In response to finding no completed user activity corresponding to the user activity, user activity processing subsystem 114 may determine that the user has abandoned the user activity. In some embodiments, the completed user activity database may include a user identifier, a time identifier, and a web page identifier corresponding to each completed user activity. By doing so, the system is able to determine the user activity is abandoned by the user.

In some embodiments, the system may determine the time threshold based on the user activity. For example, the system may determine a first threshold period of time corresponding to a first user activity. The system may determine a second threshold period of time corresponding to a second user activity. The second threshold period of time is different from the first threshold period of time. For example, user activity processing subsystem 114 may determine a first threshold period of time corresponding to a first user activity (e.g., user activity 206). User activity processing subsystem 114 may determine a second threshold period of time corresponding to a second user activity. The second threshold period of time is different from the first threshold period of time. By doing so, the system is able to accurately determine whether user activity 206 was abandoned.

In some embodiments, the system may store an abandoned user activity entry in an abandoned user activity database. For example, the system may store, in an abandoned user activity database, each abandoned user activity entry with the likelihood that the abandoned user activity would have been completed. Each abandoned user activity entry may include a user identifier, a time identifier, a web page identifier, and an activity identifier corresponding to the abandoned user activity. For example, user activity processing subsystem 114 may store, in an abandoned user activity database, each abandoned user activity entry (e.g., abandoned web activity 214, abandoned web activity 216, and abandoned web activity 218) with the likelihood that the abandoned user activity would have been completed (e.g., probability 220, probability 222, and probability 224). Each abandoned user activity entry may include a user identifier, a time identifier, a web page identifier, and an activity identifier corresponding to the abandoned user activity. By doing so, the system is able to generate a synthetic dataset from the entries of incomplete purchases.

In some embodiments, the system may generate for display user activities associated with the user. For example, the system may transmit a first request to a completed user activity database for completed user activity entries associated with the user. The system may transmit a second request to an abandoned user activity database for abandoned user activity entries associated with the user. In response to receiving the completed and abandoned user activity entries, the system may generate for display the completed and abandoned user activities on a user device associated with the user. For example, communication subsystem 112 may transmit a first request to a completed user activity database for completed user activity associated with the user. Communication subsystem 112 may transmit a second request to an abandoned user activity database for abandoned user activity entries associated with the user. In response to receiving the completed and abandoned user activities associated with the user, communication subsystem 112 may generate for display the completed and abandoned user activities on a user device associated with the user.

In some embodiments, the system may determine whether the user abandoned a user activity based on an interruption. For example, the system may determine that a user abandoned a user activity included in web activity data for the user by detecting an interruption. The interruption is associated with a new user activity. The new user activity relates to a webpage that the user has accessed after an abandoned user activity. For example, user activity processing subsystem 114 may determine that a user abandoned a user activity (e.g., user activity 206) included in web activity data (e.g., web activity data 210) for the user by detecting in web activity data for the user, an interruption. The interruption is associated with a new user activity. The new user activity relates to a webpage that the user has accessed after an abandoned user activity. By doing so, the system can accurately determine whether the user abandoned the user activity and how likely it is the user will complete the purchase in the future.

At operation 404, process 400 (e.g., using one or more components described above) may insert the abandoned user activity into abandoned web activity for a plurality of users. For example, user activity processing subsystem 114 may insert, into abandoned web activity data (e.g., web activity data 210) for a plurality of users, the abandoned user activity (e.g., user activity 206). By doing so, the system can start generating a dataset of user abandoned activities.

At operation 406, process 400 (e.g., using one or more components described above) may process, using a machine learning model, the abandoned web activity data to generate a probability for each entry in the abandoned web activity data. Each probability for a corresponding entry of the abandoned web activity data indicates a likelihood that the abandoned user activity would have been completed. For example, dataset generating subsystem 116 may process, using a first machine learning model (e.g., machine learning model 212 or model 302), the abandoned web activity data (e.g., web activity data 210) to generate a probability (e.g., probability 220, probability 222, and probability 224) for each entry in the abandoned web activity data (e.g., abandoned web activity 214, abandoned web activity 216, and abandoned web activity 218). Each probability for a corresponding entry of the abandoned web activity data indicates a likelihood that the abandoned user activity would have been completed. By doing so, the system is able to determine the likelihood a user will finish an episode based on previous watching history.

In some embodiments, the system may generate the likelihood based on previous activities. For example, the first machine learning model may be used to generate the likelihood that the abandoned user activity would have been completed based on previous activities. For example, the first machine learning model (e.g., machine learning model 212 or model 302) generates the likelihood that the abandoned user activity would have been completed based on previous activities.

At operation 408, process 400 (e.g., using one or more components described above) may generate a synthetic dataset based on entries of the abandoned web activity data with a probability above a threshold. For example, dataset generating subsystem 116 may generate a synthetic dataset (e.g., synthetic dataset 234) based on entries of the abandoned web activity data with a probability above a threshold (e.g., abandoned web activities 226 and 230). By doing so, the system may generate synthetic data based on the abandoned data.

In some embodiments, the system may generate a value for a missing identifier. For example, the system may identify a missing identifier for a user activity in a completed user activity database. The system may generate a value for the missing identifier using a generative adversarial network. The generative adversarial network is trained using the synthetic dataset. For example, dataset generating subsystem 116 may identify a missing identifier for a user activity in a completed user activity database. Dataset generating subsystem 116 may generate a value for the missing identifier using a generative adversarial network. The generative adversarial network is trained using the synthetic dataset 234.

At operation 410, process 400 (e.g., using one or more components described above) may train a machine learning model using the synthetic dataset and test the machine learning model using a completed activity dataset based on the completed user activities. The completed activity dataset may include data distinctive from the synthetic dataset. The completed user activities relate to one or more web pages where the user has completed an action. In some embodiments, the process may train, using the completed activity dataset, the second machine learning model, and test, the second machine learning model, using the synthetic dataset. For example, dataset generating subsystem 116 may train a second machine learning model (e.g., machine learning model 236) using the synthetic dataset (e.g., synthetic dataset 234) and test the second machine learning model (e.g., machine learning model 236 or model 302) using a completed activity dataset based on completed user activities. The completed activity dataset may include data distinctive from the synthetic dataset (e.g., synthetic dataset 234). The completed user activities relate to one or more web pages where the user has completed an action. By doing so, the system is able to generate a machine learning model that has more data than previous models and is tuned using synthetic data.

In some embodiments, the system may generate output using the second machine learning model. The output may include a likelihood for the user to complete a future user activity. For example, dataset generating subsystem 116 may generate output 238 using the second machine learning model (e.g., machine learning model 236 or model 302). The output may include a likelihood for the user to complete a future user activity.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims that follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method for generating synthetic data based on abandoned web activity data, the method comprising: receiving web activity data for a user, wherein the web activity data relates to a plurality of web pages accessed by the user; determining that the user abandoned a user activity included in the web activity data for the user, wherein an abandoned user activity relates to a web page that the user has accessed but not returned to for a threshold period of time; inserting, into abandoned web activity data for a plurality of users, the abandoned user activity; processing, using a first machine learning model, the abandoned web activity data, to generate a probability for each entry in the abandoned web activity data, wherein each probability for a corresponding entry of the abandoned web activity data indicates a likelihood that the abandoned user activity would have been completed; and generating a synthetic dataset based on entries of the abandoned web activity data combined with the completed activity data.

2. A method for generating synthetic data based on abandoned web activity data, the method comprising: determining that a user abandoned a user activity included in web activity data for the user, wherein an abandoned user activity relates to a web page that the user has accessed but not returned to for a threshold period of time; inserting, into abandoned web activity data for a plurality of users, the abandoned user activity; processing, using a first machine learning model, the abandoned web activity data, to generate a probability for each entry in the abandoned web activity data, wherein each probability for a corresponding entry of the abandoned web activity data indicates a likelihood that the abandoned user activity would have been completed; generating a synthetic dataset based on entries of the abandoned web activity data with a probability above a threshold; and training, a second machine learning model, using the synthetic dataset, and testing, the second machine learning model, using a testing dataset based on completed user activities, wherein the testing dataset comprises data distinctive from the synthetic dataset, and wherein the completed user activities relate to one or more web pages where the user has completed an action.

3. A method, the method comprising: determining that a user abandoned a user activity included in web activity data for the user, wherein an abandoned user activity relates to a web page that the user has accessed but not returned to for a threshold period of time; processing, using a first machine learning model, abandoned web activity data to generate a probability for each entry in the abandoned web activity data, wherein each probability for a corresponding entry of the abandoned web activity data indicates a likelihood that the abandoned user activity would have been completed; and generating a synthetic dataset based on entries of the abandoned web activity data with a probability above a threshold. 4. The method of any one of the preceding embodiments, wherein web activity data relates to a plurality of web pages accessed by the user.

5. The method of any one of the preceding embodiments, further comprising: determining a first threshold period of time corresponding to a first user activity; and determining a second threshold period of time corresponding to a second user activity, wherein the second threshold period of time is different from the first threshold period of time.

6. The method of any one of the preceding embodiments, wherein determining that the user abandoned a user activity included in the web activity data for the user further comprises: identifying a web page associated with a user activity after the threshold period of time; searching a completed user activity database for the user activity; and in response to finding no completed user activity corresponding to the user activity, determining that the user has abandoned the user activity.

7. The method of any one of the preceding embodiments, wherein the completed user activity database comprises a user identifier, a time identifier, and a web page identifier corresponding to each completed user activity.

8. The method of any one of the preceding embodiments, further comprising storing, in an abandoned user activity database, each abandoned user activity entry with the likelihood that the abandoned user activity would have been completed, wherein each abandoned user activity entry comprises a user identifier, a time identifier, a web page identifier, and an activity identifier corresponding to the abandoned user activity.

9. The method of any one of the preceding embodiments, further comprising: identifying a missing identifier for a user activity in a completed user activity database; and generating a value for the missing identifier using a generative adversarial network, wherein the generative adversarial network is trained using the training dataset.

10. The method of any one of the preceding embodiments, further comprising: transmitting a first request to a completed user activity database for completed user activity entries associated with the user; transmitting a second request to an abandoned user activity database for abandoned user activity entries associated with the user; and in response to receiving the completed user activity entries and the abandoned user activity entries, generating for display completed and abandoned user activities on a user device associated with the user.

11. The method of any one of the preceding embodiments, further comprising generating an output using the second machine learning model, wherein the output comprises a likelihood for the user to complete a future user activity.

12. The method of any one of the preceding embodiments, wherein determining that a user abandoned a user activity included in web activity data for the user further comprises detecting in web activity data for the user, an interruption, wherein the interruption is associated with a new user activity, and wherein the new user activity relates to a webpage that the user has accessed after an abandoned user activity.

13. The method of any one of the preceding embodiments, wherein the first machine learning model generates the likelihood that the abandoned user activity would have been completed based previous activities.

14. A non-transitory, computer-readable medium storing instructions that, when executed by a data processing apparatus, cause the data processing apparatus to perform operations comprising those of any of embodiments 1-13.

15. A system comprising one or more processors; and memory storing instructions that, when executed by the processors, cause the processors to effectuate operations comprising those of any of embodiments 1-13.

16. A system comprising means for performing any of embodiments 1-13.

What is claimed is:

1. A system for generating synthetic training data based on abandoned web activity data, comprising:
one or more processors; and
a non-transitory, computer-readable medium storing instructions that, when executed by the one or more processors, cause operations comprising:
receiving web activity data for a user, wherein the web activity data relates to a plurality of web pages accessed by the user;
determining that the user abandoned a user activity included in the web activity data for the user, wherein an abandoned user activity relates to a web page that the user has accessed but not returned to for a threshold period of time;
inserting, into abandoned web activity data for a plurality of users, the abandoned user activity;
processing, using a first machine learning model, the abandoned web activity data, to generate a probability for each entry in the abandoned web activity data, wherein each probability for a corresponding entry of the abandoned web activity data indicates a likelihood that the abandoned user activity would have been completed; and
generating a synthetic dataset based on entries of the abandoned web activity data combined with the completed activity data.

2. A method for generating synthetic training data based on abandoned web activity data, comprising:
determining that a user abandoned a user activity included in web activity data for the user, wherein an abandoned user activity relates to a web page that the user has accessed but not returned to for a threshold period of time;
inserting, into abandoned web activity data for a plurality of users, the abandoned user activity;
processing, using a first machine learning model, the abandoned web activity data, to generate a probability for each entry in the abandoned web activity data, wherein each probability for a corresponding entry of the abandoned web activity data indicates a likelihood that the abandoned user activity would have been completed;
generating a synthetic dataset based on entries of the abandoned web activity data with a probability above a threshold; and
training, a second machine learning model, using the synthetic dataset, and testing, the second machine learning model, using a testing dataset based on completed user activities, wherein the testing dataset comprises data distinctive from the synthetic dataset, and wherein the completed user activities relate to one or more web pages where the user has completed an action.

3. The method of claim 2, wherein web activity data relates to a plurality of web pages accessed by the user.

4. The method of claim 2, further comprising:
determining a first threshold period of time corresponding to a first user activity; and
determining a second threshold period of time corresponding to a second user activity, wherein the second threshold period of time is different from the first threshold period of time.

5. The method of claim 2, wherein determining that the user abandoned a user activity included in the web activity data for the user further comprises:
identifying a web page associated with a user activity after the threshold period of time;
searching a completed user activity database for the user activity; and
in response to finding no completed user activity corresponding to the user activity, determining that the user has abandoned the user activity.

6. The method of claim 5, wherein the completed user activity database comprises a user identifier, a time identifier, and a web page identifier corresponding to each completed user activity.

7. The method of claim 2, further comprising storing, in an abandoned user activity database, each abandoned user activity entry with the likelihood that the abandoned user activity would have been completed, wherein each abandoned user activity entry comprises a user identifier, a time identifier, a web page identifier, and an activity identifier corresponding to the abandoned user activity.

8. The method of claim 2, further comprising:
identifying a missing identifier for a user activity in a completed user activity database; and
generating a value for the missing identifier using a generative adversarial network, wherein the generative adversarial network is trained using the synthetic dataset.

9. The method of claim 2, further comprising:
transmitting a first request to a completed user activity database for completed user activity entries associated with the user;
transmitting a second request to an abandoned user activity database for abandoned user activity entries associated with the user; and
in response to receiving the completed user activity entries and the abandoned user activity entries, generating for display completed and abandoned user activities on a user device associated with the user.

10. The method of claim 2, further comprising generating an output using the second machine learning model, wherein the output comprises a likelihood for the user to complete a future user activity.

11. The method of claim 2, wherein determining that a user abandoned a user activity included in web activity data for the user further comprises detecting, in web activity data for the user, an interruption, wherein the interruption is associated with a new user activity, and wherein the new user activity relates to a web page that the user has accessed after an abandoned user activity.

12. The method of claim 2, wherein the first machine learning model generates the likelihood that the abandoned user activity would have been completed based on previous activities.

13. A non-transitory, computer-readable storage medium storing instructions that, when executed by one or more processors, cause operations comprising:
determining that a user abandoned a user activity included in web activity data for the user, wherein an abandoned user activity relates to a web page that the user has accessed but not returned to for a threshold period of time;
processing, using a first machine learning model, abandoned web activity data to generate a probability for each entry in the abandoned web activity data, wherein each probability for a corresponding entry of the abandoned web activity data indicates a likelihood that the abandoned user activity would have been completed; and
generating a synthetic dataset based on entries of the abandoned web activity data with a probability above a threshold.

14. The non-transitory, computer-readable storage medium of claim 13, wherein the instructions further cause the one or more processors to perform operations comprising training a second machine learning model using the synthetic dataset, and testing the second machine learning model using a testing dataset based on completed user activities, wherein the testing dataset comprises data distinctive from the synthetic dataset, and wherein the completed user activities relate to one or more web pages where the user has completed an action.

15. The non-transitory, computer-readable storage medium of claim 13, wherein the instructions further cause the one or more processors to perform operations comprising:
identifying a missing identifier for a user activity in a completed user activity database; and
generating a value for the missing identifier using a generative adversarial network, wherein the generative adversarial network is trained using the synthetic dataset.

16. The non-transitory, computer-readable storage medium of claim 13, wherein the instructions further cause the one or more processors to perform operations comprising:
transmitting a first request to a completed user activity database for completed user activity associated with the user;
transmitting a second request to an abandoned user activity database for abandoned user activity entries associated with the user; and
in response to receiving completed and abandoned user activities associated with the user, generating for display the completed and abandoned user activities on a user device associated with the user.

17. The non-transitory, computer-readable storage medium of claim 13, wherein determining that the user abandoned a user activity included in the web activity data for the user further comprises:
identifying a web page associated with a user activity after the threshold period of time;
searching a completed user activity database for the user activity; and
in response to finding no completed user activity corresponding to the user activity, determining that the user has abandoned the user activity.

18. The non-transitory, computer-readable storage medium of claim 17, wherein the completed user activity database comprises a user identifier, a time identifier, and a web page identifier corresponding to each completed user activity.

19. The non-transitory, computer-readable storage medium of claim 13, further comprising:
determining a first threshold period of time corresponding to a first user activity; and
determining a second threshold period of time corresponding to a second user activity, wherein the second threshold period of time is different from the first threshold period of time.

20. The non-transitory, computer-readable storage medium of claim 13, wherein the instructions further cause the one or more processors to perform operations comprising generating an output using a second machine learning model, wherein the output comprises a likelihood for the user to complete a future user activity.
